(19) United States
(12) Patent Application Publication
(10) Pub. No.: US 2013/0246402 A1
(43) Pub. Date: Sep. 19, 2013

(54) SCREEN DATA GENERATING APPARATUS FOR PROGRAMMABLE DISPLAY DEVICE

(71) Applicant: Tomohiro Iwaki, Chiyoda-ku (JP)

(72) Inventor: Tomohiro Iwaki, Chiyoda-ku (JP)

(21) Appl. No.: 13/699,337

(22) PCT Filed: Mar. 19, 2012
(86) PCT No.: PCT/JP12/57007

§ 371 Date: Nov. 21, 2012

(51) Int. Cl. G06F 17/30

(52) U.S. Cl. CPC G06F 17/3053
USPC 707/723

(57) ABSTRACT

A screen data generating apparatus for a programmable display device includes a graphic-information recording unit in which keywords are stored, a first data recording unit that records therein setting information of screen data in association with the keywords, a second data recording unit that records therein determination reference data indicating a level of difficulty set in each operation regarding graphic software and user data, an information searching unit that searches for the setting information associated with the keyword matching a word input, a characteristic determination unit that determines a learning level and preferences of a user based on the determination reference data and the user data, a control unit that assigns a rank to the setting information based on a determination result of the characteristic determination unit, and an information presenting unit that displays the setting information to which a rank is assigned on a display unit.

### FIELD

The present invention relates to a screen data generating apparatus for a programmable display device.

### BACKGROUND

In recent years, screen data for a programmable display device is often generated by using existing data without generating a new screen. Furthermore, from a viewpoint of reduction of man-hours in generating a screen, manufactures that supply screen data generating apparatuses for a programmable display device provide a number of pieces of sample data and template data, and by using screens and preset parts from such data, it is possible to generate screen data including intended functions in a short time.

However, when such existing data is used, it is required for a user himself to prepare base screen data and data including a screen on which an intended function is set. There is no problem when the user knows the location in which the base data is stored; however, when the user has forgotten the location in which the base data is stored or a file of the base data, it is required to open and check screen data stored in a computer or a recording medium one by one. In a case of data including a plurality of screens, it is further required to check these screens one by one, and this leads to require a lot of labor until finding an intended screen.

To save this labor, recent screen data generating apparatuses for a programmable display device support a search for template data, library, and parts data. However, as the search is performed based on a keyword set in advance in the screen or the template data, it is required to set the keyword in advance or input a character string matching the keyword, which is not convenient to use.

Furthermore, as an actual appearance or setting cannot be recognized even in a sample screen or a template screen provided on the Internet such as a Webpage, it is required to download and open the screen to determine whether it is helpful to generate an intended function or whether it can be used at the learning level of the user.

Patent Literature 1 discloses a technique in which an image to be displayed on a display screen is provided in a multilevel hierarchical structure, and on the display screen, an image of a currently selected level is displayed, and at the same time, next image information for allowing a user to predict at least an image that is possibly displayed next is displayed. The user can easily predict the image to be displayed next based on the displayed next image information.

### CITATION LIST

### Patent Literature

Patent Literature 1: Japanese Patent Application Laid-open No. 2010-26627

### SUMMARY

### Technical Problem

However, the conventional technique mentioned above is merely applied when using a programmable display device, but is not applied when generating screen data for the programmable display device to search for screen data or template data suitable for the user's intent in a prompt manner and to efficiently present contents according to the learning level and preferences of the user.

The present invention has been achieved in view of the above problem, and an object of the present invention is to provide a screen data generating apparatus for a programmable display device that enables a search for screen data or template data suitable for a user's intent in a prompt manner and that can efficiently present contents according to the learning level and preferences of a user.

### Solution to Problem

In order to solve the above problem and in order to attain the above object, in a screen data generating apparatus for a programmable display device formed on a computer including an input interface and a display unit by the computer executing graphic software, the screen data generating apparatus of the present invention, includes: a graphic-information recording unit in which a plurality of preset keywords are stored; a first data recording unit that records therein setting information for identifying each of plural pieces of screen data recorded in an external storage unit connected to or incorporated in the computer in association with at least any one of the keywords for each of the screen data; a second data recording unit that records therein determination reference data indicating a level of difficulty set in each operation with respect to the graphic software, and accumulates user data indicating an execution environment of the graphic software and a content of an operation performed by a user with respect to the input interface; an information searching unit that searches for the setting information associated with a keyword matching a word input from the input interface from the first data recording unit; a characteristic determination unit that determines a learning level and preferences of a user based on the determination reference data recorded in the second date recording unit and the user data accumulated in the second data recording unit; a control unit that assigns a rank to the setting information searched by the information searching unit based on a determination result of the characteristic determination unit; and an information presenting unit that displays the setting information to which a rank is assigned by the control unit on the display unit.

### Advantageous Effects of Invention

The screen data generating apparatus for a programmable display device enables a search for screen data or template data suitable for a user's intent in a prompt manner and can efficiently present contents according to the learning level and preferences of a user.

### BRIEF DESCRIPTION OF DRAWINGS

FIG. 1 depicts a configuration of a screen data generating apparatus for a programmable display device according to an embodiment of the present invention.

FIG. 2 is a flowchart of an operation procedure performed with respect to the screen data generating apparatus for a programmable display device when project data is newly generated.

FIG. 3 is a flowchart of an operation procedure performed with respect to the screen data generating apparatus for a programmable display device when screen data and parts data are newly added to currently opened project data.

FIG. 4 is an example of a dialogue for specifying a search condition.

FIG. 5 is an example of a window for a user to specify a search condition.

FIG. 6 depicts a flow of data in the screen data generating apparatus for a programmable display device.

FIG. 7 is a flowchart of a flow of a process from an input of a keyword by a user by operating an I/F to a presentation of setting information on a display unit.

FIG. 8 depicts a flow of a process of an information searching unit collecting data from an external storage unit and then accumulating the collected data in first and second data recording units.

### DESCRIPTION OF EMBODIMENTS

Exemplary embodiments of a screen data generating apparatus for a programmable display device according to the present invention will be explained below in detail with reference to the accompanying drawings. The present invention is not limited to the embodiments.

### Embodiment

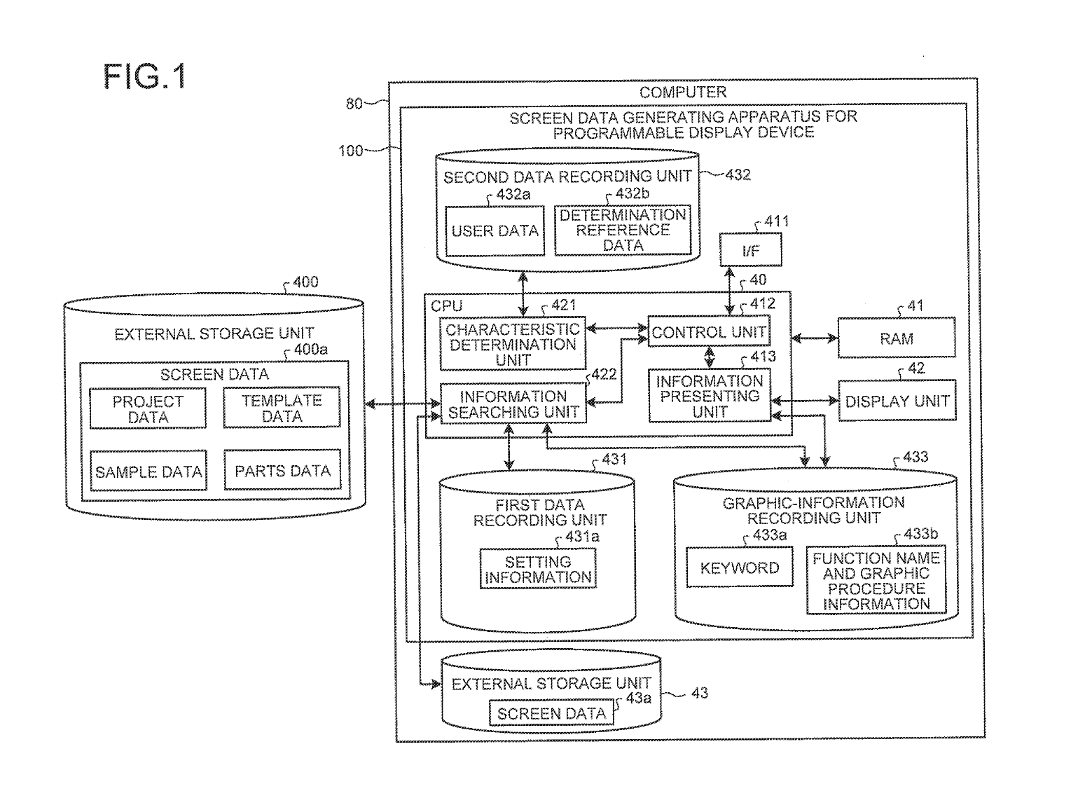

FIG. 1 depicts a configuration of a screen data generating apparatus for a programmable display device according to an embodiment of the present invention. A screen data generating apparatus 100 for a programmable display device is constituted on a computer 80 including a CPU (Central Processing Unit) 40, a RAM (Random Access Memory) 41, a display unit 42, an I/F (Interface) 411, a first data recording unit 431, a second data recording unit 432, a graphic-information recording unit 433, and an external storage unit 43, by the CPU 40 executing graphic software using the RAM 41 as a work area. A control unit 412, an information searching unit 422, a characteristic determination unit 421, and an information presenting unit 413 are formed on the CPU 40 by the CPU 40 executing the graphic software using the RAM 41 as a work area.

The external storage unit 43 is incorporated in the computer 80, in which project data, template data, sample data, parts data, and the like are recorded. The external storage unit can be an HDD (Hard Disk Drive), a semiconductor memory device, or a device that reads and writes information with respect to a removable information recording medium such as an optical disk.

An external storage unit 400 is connected to the computer 80, so that the computer 80 is configured to be able to read and write screen data 400a (project data, template data, sample data, parts data, and the like) with respect to the external storage unit 400. The external storage unit 400 includes not only an information storage device but also a computer connected via a communication line or a network.

The I/F 411 is an input interface such as a keyboard. The display unit 42 is a display device such as an LCD (Liquid Crystal Display). The first data recording unit 431, the second data recording unit 432, and the graphic-information recording unit 433 are devices for recording information or data in a nonvolatile manner, such as an HDD or a semiconductor memory device.

In the first data recording unit 431, as explained later, setting information 431a obtained by the information searching unit 422 performing a search with respect to the external storage units 43 and 400 is accumulated as needed. The setting information is information used for identifying screen data 43a and the screen data 400a stored in the external storage units 43 and 400, and the setting information includes the stored location, type, size, and update date and time of data, the type and number of arranged parts, comments attached to the data, and the like. The first data recording unit 431 stores therein cache data, so that once the cache data is generated, it is configured that the information searching unit 422 can perform a search faster than that of the first time by using the cache data at the next search.

The second data recording unit 432 accumulates information related to an operation performed by a user with respect to the I/F 411 as user data 432a as needed. In the second data recording unit 432, determination reference data 432b that serves as a reference of determining the learning level, preferences, and the like of the user is recorded. The screen data generating apparatus 100 for a programmable display device has a function of overwriting the determination reference data 432b recorded in the second data recording unit 432 according to a selection of a candidate by the user from candidates presented on the display unit 42. In other words, the screen data generating apparatus 100 for a programmable display device has a function of learning the determination reference data 432b. The determination reference data 432b includes information on a level of difficulty set for each operation with respect to the screen data generating apparatus 100 for a programmable display device, a recommended specification of the computer 80 required to execute graphic software, and the like. The characteristic determination unit 421 determines the learning level, preferences, and the like of the user based on the user data 432a and the determination reference data 432b accumulated in the second data recording unit 432.

In the graphic-information recording unit 433, a “keyword” that serves as a word and a function name used in graphic software is recorded as a keyword 433a, and a plurality of related words are registered in each keyword 433a. For example, in a keyword “alarm”, related words such as “error, system, user, display, history, output, confirmation, relay, maintenance” are registered. In the graphic-information recording unit 433, function names included in the screen data generating apparatus 100 for a programmable display device, function names in products of other manufactures, and function name and graphic procedure information 433b that are information on a general usage and a graphic procedure are also recorded. The keyword 433a, the function name and graphic procedure information 433b recorded in the graphic-information recording unit 433 can be updated by a user performing an operation with respect to the I/F 411 in a direct manner, by the information searching unit 422 obtaining the latest keywords, function names, and graphic procedure information, and importing information or replacing information.

The control unit 412 recognizes a keyword and a search condition input by an user operating the I/F 411, and instructs the information searching unit 422 to perform a search of corresponding information. Furthermore, the control unit 412 receives any input of operations by the user from the I/F 411, and transmits corresponding information to the characteristic determination unit 421. The control unit 412 outputs information obtained from the information searching unit 422 and information obtained from the characteristic determination unit 421 to the information presenting unit 413.

The information searching unit 422 performs a search process among pieces of the setting information recorded in the first data recording unit 431. The information searching unit 422 also has a function of collating information (a keyword) received from the control unit 412 with the keyword 433a recorded in the graphic-information recording unit 433 and converting the information into another keyword that is most suitable for the search process. When a user specifies the location of a recording medium for a search, the information searching unit 422 also performs a search process among various pieces of information recorded in the external storage units 43 and 400 following path information (a stored location of data) input by an operation with respect to the I/F 411. The information searching unit 422 returns the setting information obtained by the search process to the control unit 412. Furthermore, the information searching unit 422 accumulates setting information obtained from the external storage units 43 and 400 in the first data recording unit 431 as needed.

The characteristic determination unit 421 accumulates information related to operations by a user with respect to, the I/F 411 transmitted from the control unit 412 as the user data 432a, and at the same time, the characteristic determination unit 421 determines the learning level of the user by collating the user data 432a with the determination reference data 432b and returns the learning level and preferences of the user to the control unit 412.

The information presenting unit 413 displays setting information according to the information input by a user and an operation status of the user on the display unit 42 based on the information received from the control unit 412.

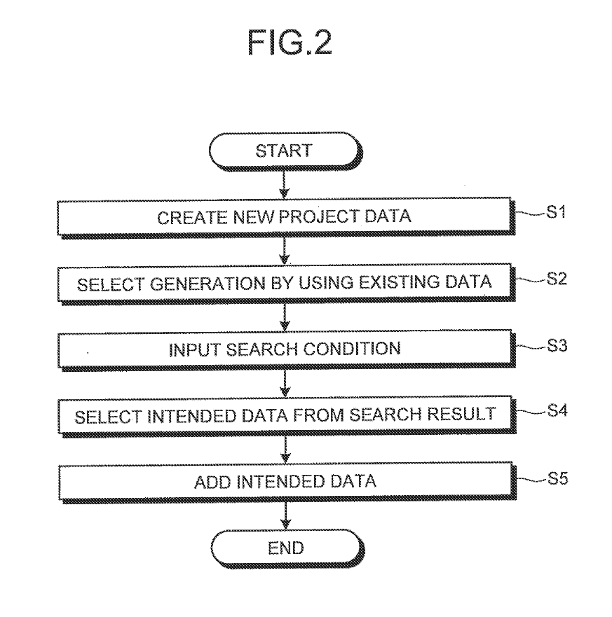

FIG. 2 depicts an operation procedure performed with respect to the screen data generating apparatus 100 for a programmable display device when project data is newly generated. A new creation of project data is selected at the time of starting the screen data generating apparatus for a programmable display device (Step S1), and then a usage of existing data and template data is selected (Step S2), by which a dialogue for inputting a search condition is displayed on the display unit 42. A search process of setting information is performed by inputting the search condition on the dialogue displayed on the display unit 42 (Step S3), and setting information associated with intended existing project data and template data is selected from a search result (Step S4), by which the project data and the template data are added to the project data to be newly generated (Step S5).

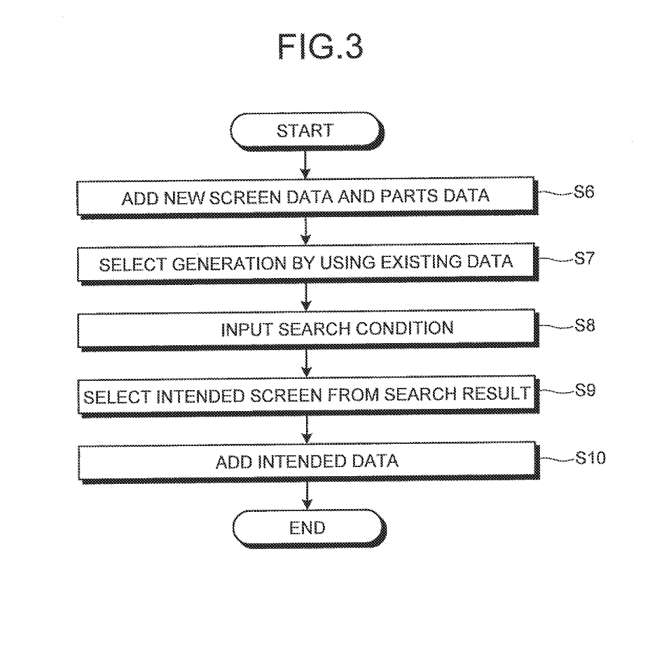

FIG. 3 depicts an operation procedure performed with respect to the screen data generating apparatus 100 for a programmable display device when screen data and parts data are newly added to currently opened project data. When screen data and parts data at the time of editing the project data (Step S6) are added, by selecting a usage of the existing data (Step S7), a dialogue window for inputting a search condition is displayed on the display unit 42. A search process of the setting information is performed by inputting the search condition on the dialogue displayed on the display unit 42 (Step S8), and setting information associated with intended existing project data and template data is selected from a search result (Step S9), by which the project data and the template data are added to the project data to be newly generated (Step S10).

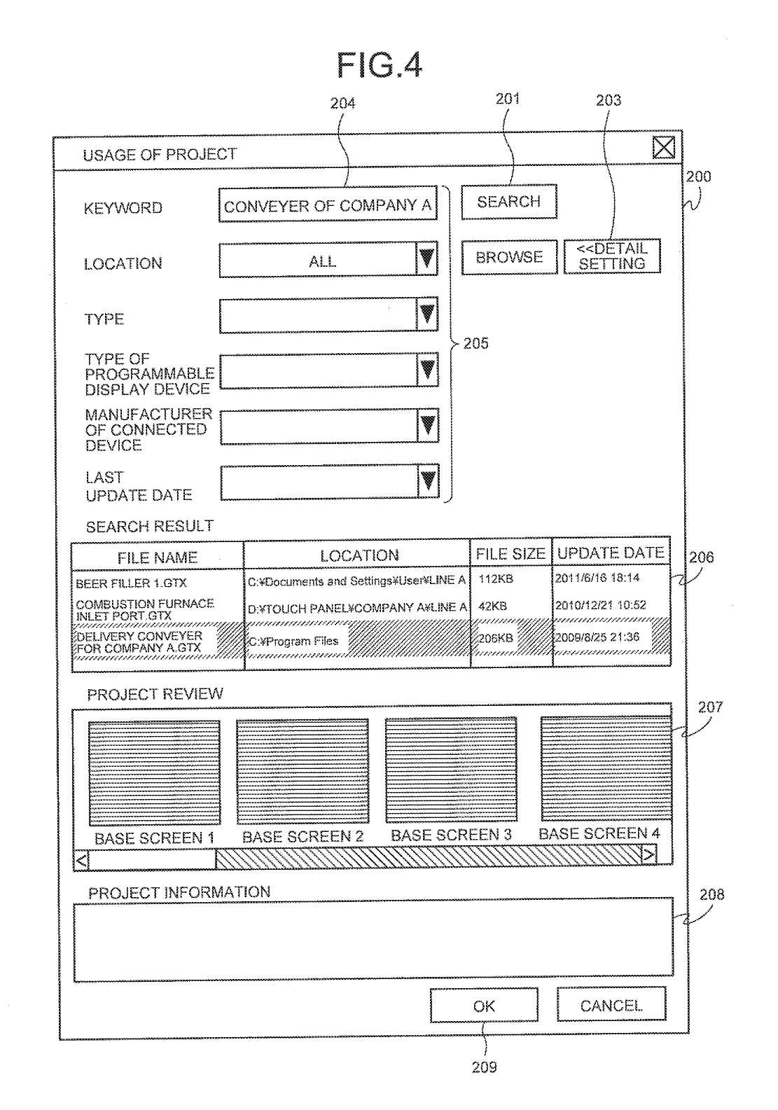

FIG. 4 is an example of a dialogue for specifying a search condition. A search-condition specifying dialogue 200 is displayed on the display unit 42 by the information presenting unit 413 when a user inputs an instruction for using existing project data by operating the I/F 411. As the user pressing a search button 201 after inputting a keyword on a keyword input column 204 by operating the I/F 411, a search process is started by the information searching unit 422. A search result from the information searching unit 422 is listed on a search result column 206. The search result from the information searching unit 422 matches the keyword input by the user, in which the operation environment, the learning level, and preferences of the user are taken into consideration.

When the user selects arbitrary setting information from the search result listed by operating the I/F 411, the control unit 412 instructs the information presenting unit 413 to preview and display selected setting information 208 and a screen 207 included in screen data indicated by the selected setting information 208 on the display unit 42. When the intended data is found, the user presses an OK button 209 in a state where the desired setting information is selected from the search result listed by operating the I/F 411. With this operation, the control unit 412 adds data identified by the setting information in a state of being selected from the listed search result to a project.

Furthermore, other than keywords, it is possible to specify detailed information 205 such as a search target (a type of data) and a search location, a type of a display device, and a manufacturer of a connected device. As the user pressing a detail setting button 203 by operating the I/F 411, it is possible to specify the detailed information such as a search target and a search location, a type of a programmable display device, and a manufacturer of the connected device.

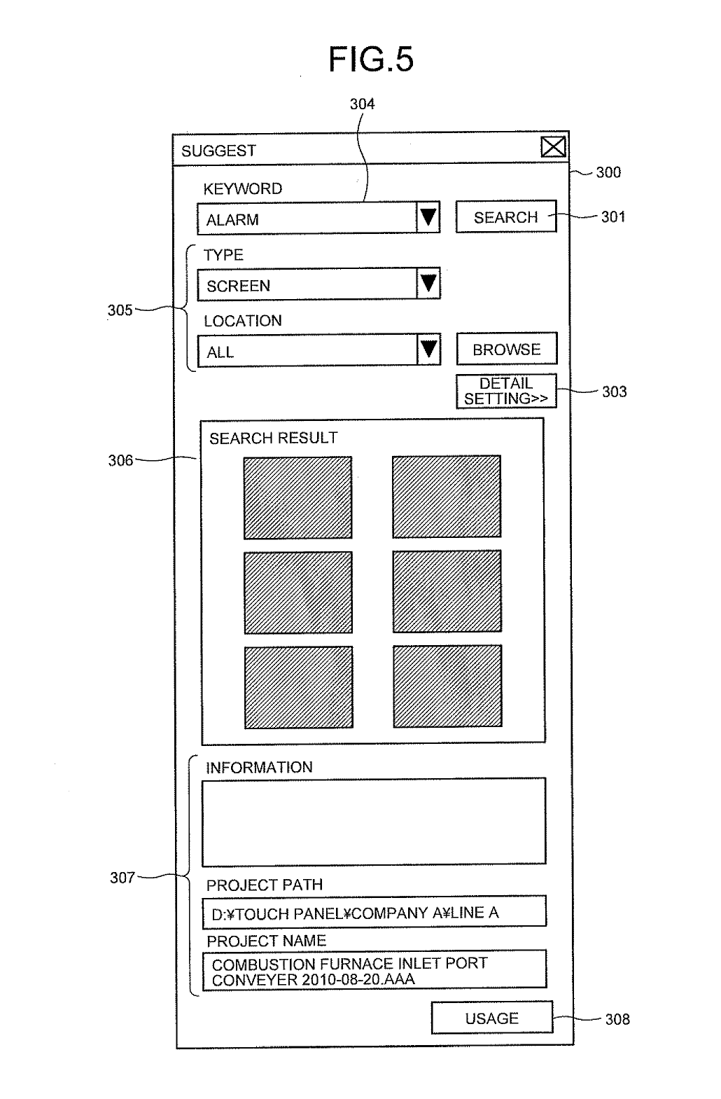

FIG. 5 is an example of a window for a user to specify a search condition. A search-condition specifying window 300 is displayed on the display unit 42 by the control unit 412 when a user inputs an instruction for adding a screen or a function to currently opened project data by operating the I/F 411. The search-condition specifying window 300 is configured to input and present the same information as in the search-condition specifying dialogue 200. A thumbnail is displayed in a search result column 306 by the user pressing a search button 301 after inputting a keyword in a keyword input column 304 by operating the I/F 411. Furthermore, information including a type and a project path of the display device, a project name, and the like is displayed in an information display column 307. Upon confirmation of the information displayed in the information display column 307, the user presses a usage button 308 by operating the I/F 411. With this operation, the control unit 412 adds data specified by the setting information in a selected state among the listed search results to a project.

Further, other than keywords, it is possible to specify detailed information 305 such as a type of data and a search location. As the user pressing a detail setting button 303 by operating the I/F 411, it is possible to specify detailed information such as a search target and a search location, a type of a display device, and a manufacturer of a connected device.

An operation of the screen data generating apparatus for a programmable display device is described below in detail.

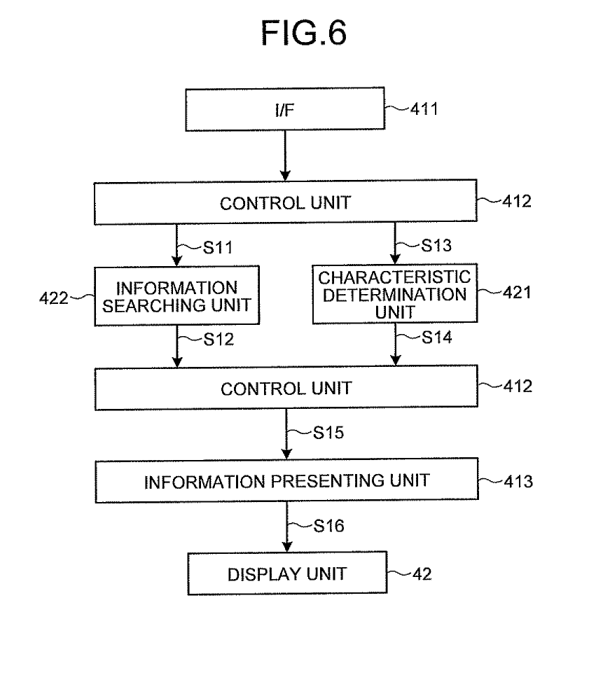

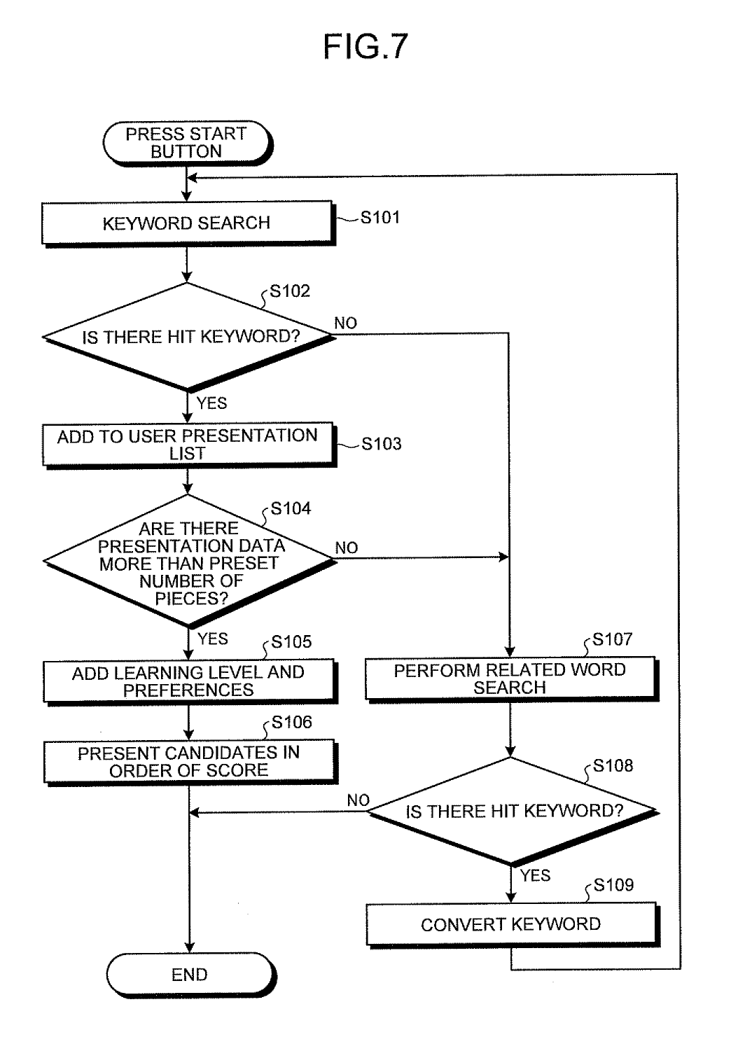

FIG. 6 depicts a flow of data in the screen data generating apparatus for a programmable display device. FIG. 7 is a flowchart of a flow of a process from an input of a keyword by a user by operating the I/F to a presentation of setting information on a display unit.

When performing a search process of setting information in the first data recording unit 431, the information searching unit 422 performs a “keyword search” for searching for the setting information associated with the keyword 433a that matches a keyword input by a user by operating the I/F 411 from the first data recording unit 431 (FIG. 7: Step S101). At this time, the control unit 412 instructs the information searching unit 422 to search for the setting information (FIG. 6: S11), and the information searching unit 422 performs the keyword search with respect to the first data recording unit 431. As a result of the keyword search, when there is hit data (FIG. 7: YES at Step S102), the searched setting information is added to a presentation list (FIG. 7: Step S103). Thereafter, it is checked whether the number of pieces of the setting information included in the presentation list is equal to or larger than a preset number of displaying items set in advance (FIG. 7: Step S104).

When the setting information associated with the keyword 433a that matches the keyword input by the user by operating the I/F 411 is not recorded in the first data recording unit 431 (FIG. 7: NO at Step S102), and when the number of pieces of the setting information included in the presentation list is smaller than the preset number of displaying items (FIG. 7: NO at Step S104), the information searching unit 422 continues to perform a “related word search” (FIG. 7: Step S107).

When the related word search is performed, the keyword 433a including a keyword input by the user by operating the I/F 411 as a related word is searched in the graphic-information recording unit 433 (FIG. 7: Step S108). When the keyword is hit (FIG. 7: YES at Step S108), the information searching unit 422 automatically converts the keyword input by the user by operating the I/F 411 into another keyword 433a detected at Step S106 (FIG. 7: Step S109).

As an example, it is assumed that the user has input words “error, history, display” as the keywords by operating the I/F 411. The information searching unit 422 performs a keyword search for the words “error, history, display” at Step S101. If the keyword 433a including the words “error”, “history”, “display” is not registered in the graphic-information recording unit 433, the determination at Step S102 in FIG. 7 is “NO”, and therefore the information searching unit 422 performs a related word search for the words “error”, “history”, and “display” at Step S107. The keyword 433a named “alarm” including the three words in the related word is then extracted, and therefore the determination at Step S108 is “YES”. The information searching unit 422 converts the keyword including “error, history, display” into “alarm” at the process of Step S109. The information searching unit 422 searches for the setting information associated with the keyword “alarm” in the first data recording unit 431 by performing the keyword search at Step S101 in FIG. 7.

When there is no hit for the keyword including all the related words in the related word search, the information searching unit 422 performs a related word search for a keyword including a part of the related words. In the example described above, the information searching unit 422 performs a related word search by combining the three words, such as “error, history”, “error, display”, and “history, display”. When there is no hit for any one of the keywords (FIG. 7: NO at Step S108), the process is terminated.

When the number of pieces of the setting information included in the presentation list is equal to or larger than the preset number of displaying items (FIG. 7: YES at Step S104), the information searching unit 422 transmits the setting information included in a candidate list to the control unit 412 as the search result (FIG. 6: S12).

The information searching unit 422 sets a score on the setting information included in the candidate list. In this example, the score is set in a manner such that 100 points are assigned to the data that includes all the words “error”, “history”, and “display” in the keyword, 60 points are assigned to the data that includes one of the words in the keyword, and 30 points are assigned to the data that does not include these words in the keyword but detected with another keyword that includes two of these words in the related word.

The control unit 412 receives a determination result of the learning level and preferences of the user determined by the characteristic determination unit 421 based on the user data recorded in the second data recording unit 432 from the characteristic determination unit 421, and adds the received determination result to the candidate list (FIG. 7: Step S105). At this time, the control unit 412 instructs the characteristic determination unit 421 to determine the learning level and preferences of the user (FIG. 6: S13). The characteristic determination unit 421 reads the user data 432a and the determination reference data 432b from the second data recording unit 432. The characteristic determination unit 421 determines the learning level and preferences of the user based on the user data 432a and the determination reference data 432b, and returns the determination result to the control unit 412 (FIG. 6: S14). The control unit 412 corrects the score of the search process result of the setting information in the first data recording unit 431 according to the learning level and preferences of the user determined based on the user data 432a and the determination reference data 432b recorded in the second data recording unit 432. With this operation, the control unit 412 transmits the setting information determined to be most suitable for the user to the information presenting unit 413 (FIG. 6: S15). The setting information most suitable for the user can be searched by varying a weight of the score corrected by the control unit 412.

For example, when a user uses a computer of a low specification and when many pieces of setting information matching a behavioral pattern often performed by a beginner user are detected, the control unit 412 transmits the setting information to the information presenting unit 413 while reducing the amount of data to be searched, reducing the time required for the search, and then reducing the number of candidates to be presented than usual, such that a screen of a simpler configuration is displayed on the display unit 42.

Furthermore, it is possible to display setting information according to the preferences of the user on the display unit 42 at a higher rank by recording the color, shape, and type of parts frequently used by the user in the second data recording unit 432 as the user data 432a. For example, when the user arranges many parts of type such as “blue” and “real” on the screen, setting information of the screen data generated with the type of “real” becomes a search result at the higher rank, and is displayed as a higher-rank candidate when the information presenting unit 413 displays the search result on the display unit 42.

The information presenting unit 413 displays the setting information transmitted from the control unit 412 on the display unit 42 in the order of the score (FIG. 7: Step S106). At this time, the information presenting unit 413 transmits the setting information in the order of the score to the display unit 42 (FIG. 6: S16). As the user selecting the setting information included in the search result displayed on the display unit 42 by operating the I/F 411, the control unit 412 uses screen data specified by the setting information to generate a new screen or adds the screen data to a screen being generated.

Meanwhile, it is also possible to configure that a hint for a graphic procedure is presented or guidance for the next operation is also presented according to the learning level of the user. In this case, the control unit 412, which has received a determination result of the learning level and preferences of the user from the characteristic determination unit 421, sends an instruction for reading the function name and graphic procedure information 433b from the graphic-information recording unit 433, setting the read information as the setting information, and displaying the setting information on the display unit 42 to the information presenting unit 413. The control unit 412 then receives information on user's selection with respect to the result presented on the display unit 42 by the information presenting unit 413 as a feedback from the I/F 411, and sends an instruction for updating the determination reference data 432b to the characteristic determination unit 421. In this manner, by updating the determination reference data 432b, when there is no improvement even with several repeated presentations of the guidance to the user, it is possible to switch to guidance to display more suitable information to a beginner using an alternative word or when only some specific operations common to beginner users are detected for many times but other operations common to the beginners are not detected, it is possible to exclude the specific operations from an evaluation by determining the specific operations as habitual operations of the particular user.

The determination reference data 432b accumulated in the computer 80 and the function name and graphic procedure information 433b can be written in (exported to) another computer connected to the computer 80 via a network or the like or a recording medium such as a memory card. Conversely, the determination reference data 432b and the function name and graphic procedure information can be loaded (imported) from a recording medium such as a memory card or another computer connected to the computer via a network or the like. By executing the export or the import of these pieces of information, it is possible to implement the same operation environment in another computer as in the computer 80, or conversely, it is possible to implement the same operation environment in the computer 80 as in another computer.

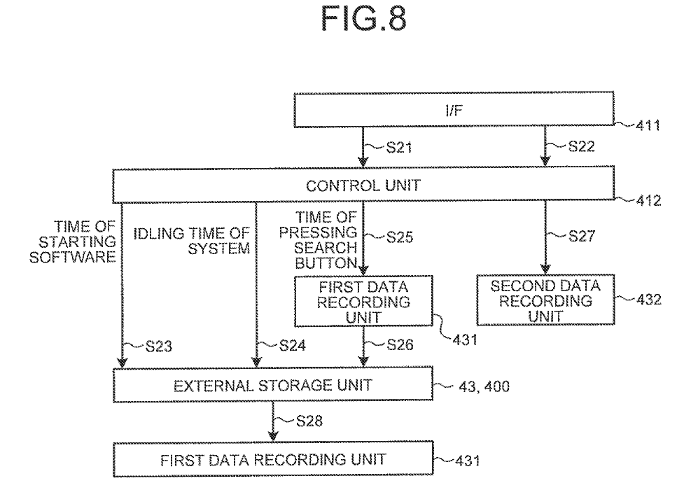

FIG. 8 depicts a flow of a process of an information searching unit collecting data from an external storage unit and then accumulating collected data in the first and second data recording units. When a user issues a command to perform a search process by operating the I/F 411, the information searching unit 422 searches setting information in the first data recording unit 431 (FIG. 8: S21 and S25). The search process with respect to the external storage unit 400 is further performed at the time of installing and starting graphic software (FIG. 8: S23), at an idling time of a system, or the like, as well as in a case where the user inputs a keyword by operating the I/F 411 (FIG. 8: S21, S25, and S26).

The screen data generating apparatus 100 for a programmable display device automatically acquires the setting information from the screen data recorded in the external storage units 43 and 400, and records the acquired setting information in the first data recording unit 431.

Specifically, after the user issues the command to perform a search process by operating the I/F 411 (FIG. 8: S21 and S25), the information searching unit 422 searches the screen data of the external storage units 43 and 400 (FIG. 8: S26). Furthermore, the information searching unit 422 performs the search of the screen data stored in the external storage unit 400 at the time of installing and starting the graphic software (FIG. 8: S23) and the idling time of the system (FIG. 8: S24). The information searching unit 422 extracts setting information on the screen data detected by the search, and records the setting information in the first data recording unit 431. The information searching unit 422 performs an association of the setting information recorded in the first data recording unit 431 with the keyword 433a stored in the graphic-information recording unit 433, generates an index file according to the keyword 433a, and records the index file in the first data recording unit 431 (FIG. 8: S28). By recording the index file in the first data recording unit 431, the information searching unit 422 can increase the speed of the process of searching the data in the first data recording unit 431.

Furthermore, the screen data generating apparatus 100 for a programmable display device automatically collects data on an operation environment of the user and an operation condition of the software (FIG. 8: S22), and records the collected data in the second data recording unit 432 as the user data 432a (FIG. 8: S27).

Specifically, the control unit 412 collects a log with respect to the environment of running the graphic software (a specification of a CPU, a capacity of an HDD, a type of an OS (Operating System), and installed software) and an operation performed by the user with the I/F 411 (an item selected in a menu, a function that is frequently used, a time required for setting, and the like), and transmits the collected information to the information searching unit 422 to record the information in the second data recording unit 432, thereby setting the recorded information as the user data 432a.

The information searching unit 422 accumulates the data obtained by the search process in the first data recording unit 431 as needed. At this time, by associating the data with the keyword 433a registered in the graphic-information recording unit 433, it is possible to perform the next search at a higher speed. Furthermore, by performing an association with the setting information to which information on function names in the screen data generating apparatus 100 for a programmable display device, function names in software of other manufactures, and a general graphic procedure is added, based on the function name and graphic procedure information 433b recorded in the graphic-information recording unit 433, it is possible to perform the search process at a higher accuracy to present the search result to the user.

According to the present embodiment, it is possible to use project data generated by a user in the past in a simple manner. Furthermore, it is possible to efficiently generate screen data for a programmable display device by using sample data, template data, and parts data prepared in advance. Further, because information and data suitable for the learning level and preferences of a user can be presented, it is possible to generate a screen by simply selecting desired information or data from presented contents.

### INDUSTRIAL APPLICABILITY

As described above, the screen data generating apparatus for a programmable display device according to the present invention is useful in a feature that it is possible to search for screen data or template data suitable for a user's intent in a prompt manner and to efficiently present contents according to the learning level and preferences of a user, and the screen data generating apparatus is particularly suitable to be shared by users with different learning levels.

### REFERENCE SIGNS LIST

40 CPU

41 RAM

42 display unit

43, 400 external storage unit

43a, 400a screen data

80 computer

100 screen data generating apparatus for programmable

display device

200 search-condition specifying dialogue

201, 301 search button

203, 303 detail setting button

204, 304 keyword input column

205, 305 detailed information

206, 306 search result column

207 screen

208 selected setting information

209 OK button

300 search-condition specifying window

307 information display column

308 usage button

411 I/F

412 control unit

413 information presenting unit

421 characteristic determination unit

422 information searching unit

431 first data recording unit

432 second data recording unit

432a user data

432b determination reference data

433 graphic-information recording unit

433a keyword

433b function name and graphic procedure information

1. A screen data generating apparatus for a programmable display device formed on a computer including an input interface and a display unit by the computer executing graphic software, the screen data generating apparatus comprising:
a graphic-information recording unit in which a plurality of preset keywords are stored;
a first data recording unit that records therein setting information for identifying each of plural pieces of screen data recorded in an external storage unit connected to or incorporated in the computer in association with at least any one of the keywords for each of the screen data;
a second data recording unit that records therein determination reference data indicating a level of difficulty set in each operation with respect to the graphic software, and accumulates user data indicating an execution environment of the graphic software and a content of an operation performed by a user with respect to the input interface;
an information searching unit that searches for the setting information associated with a keyword matching a word input from the input interface from the first data recording unit;
a characteristic determination unit that determines a learning level and preferences of a user based on the determination reference data recorded in the second date recording unit and the user data accumulated in the second data recording unit;
a control unit that assigns a rank to the setting information searched by the information searching unit based on a determination result of the characteristic determination unit; and
an information presenting unit that displays the setting information to which a rank is assigned by the control unit on the display unit.

2. The screen data generating apparatus for a programmable display device according to claim 1, wherein
a related word associated with each of the keywords is recorded in the first data recording unit, and
when number of pieces of the setting information searched from the first data recording unit by the information searching unit is equal to or smaller than a predetermined number, the information searching unit converts a word input from the input interface into the keyword associated with the related word matching the word, and searches the setting information associated with the converted keyword from the first data recording unit.
